(19) United States
(12) Patent Application Publication
(10) Pub. No.: US 2006/0041690 A1
(43) Pub. Date: Feb. 23, 2006

(54) Software communication between MPEG layer and servo layer

(76) Inventors: Bede Lee, Taipei (TW); Nick Jian, Taipei (TW); Sam Shen, Taipei (TW); Einsent Huang, Taipei (TW); Peter Wu, Taipei (TW); Shangen Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/206,062

(22) Filed: Aug. 18, 2005

Related U.S. Application Data
(60) Provisional application No. 60/602,322, filed on Aug. 18, 2004.

(51) Int. Cl. G06F 13/14

(52) U.S. Cl. 710/5

(57) ABSTRACT

The present invention discloses a multi-layer software architecture which includes a MPEG application, a plurality of message queues, and a servo software. An optical disc reader is controlled and directed by the servo software in order to read the information on the optical disc. Both the MPEG application and the servo software share at least a common data buffer as the storage of read-out information. In the embodiment, the MPEG application receives information from the servo software for playback by means of the plurality of message queues.

### CROSS REFERENCE TO RELATED APPLICATIONS

This application claims the benefit of U.S. Provisional Application No. 60/602,322, filed on Aug. 18, 2004, which is herein incorporated by reference for all intents and purposes.

### BACKGROUND OF THE INVENTION

1. Field of the Invention

The present invention generally relates to software communication, and more particularly to software communication between MPEG (Motion Picture Expert Group) layer and servo layer.

2. Description of the Prior Art

Today, vast amount of motion pictures are stored in various forms of optical discs, such as VCDs and DVDs. Traditional playback process of multimedia optical discs mainly evolves two major steps: first, reading data from an optical disc; second, decoding read-out data. The data reading part is usually controlled by a servo chip. At the mean time, audio and video output is generated by a decode chip according to those read-out data.

Please refer to the FIG. 1, which is a block diagram shows conventional playback architecture 100. In this regard, the playback architecture 100 comprises an ATA (Advanced Technology Attachment) bus 110, a servo chip 120, and a MPEG decode chip 130, both attaching to the ATA bus 100. As a controller of an optical disc reader 140, the servo chip 120 returns data on the optical disc in response of the ATAPI (ATA Programmable Interface) commands. A servo buffer 125, directly attached to the servo chip 120, is configured as a data buffer. In this architecture, the MPEG decode chip 130 is also connected to the ATA bus 110. Similarly, a MPEG buffer, directly attached to the MPEG chip, is configured as a data buffer, too.

Please refer to the FIG. 2, which is a flowchart diagram of the architecture 100 shown in the FIG. 1. In step 210, a data request command is issued, by the MPEG decode chip 130, to the servo chip 120 via the ATA bus 110. Next, data requested is read out by the disc reader 140 following the instructions of the servo chip 120 in step 220. The read-out data is stored in the servo buffer 125 in step 230. In the consequence, the read-out data is copied to the MPEG buffer 135 via the ATA bus 110 in step 240. At last, in step 250, the copied read-out data in the MPEG buffer 135 is decoded for generating audio and video outputs.

In most cases, since there may exist other devices for sharing the ATA bus 110, the transfer of read-out data would be delayed by resource conflict. Besides, the read-out data is duplicated in two places, such as the servo buffer 125 and the MPEG buffer 135, in the same time. The duplication process wastes time and space. Moreover, since the clock rate of the ATA bus 100 may be different from those clock rates operated by the servo buffer 125 and/or the MPEG buffer 135, additional FIFO (First-In/First-Out) structures may be necessary in the implementations.

In addition, once the size of the servo buffer 125 is as large as the size of requested data, the servo chip 120 has to wait for duplication complete in prior to read next data. Therefore the reading and the duplication could not be performed concurrently. Hence, the playback procedure would be stalled while the read error occurs or the ATA bus 110 is occupied.

Accordingly, there exists a need for a software communication architecture for solving the stated problems in order to improve the competitiveness of optical disc playback apparatus.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention provides a multi-tier structure, which comprises a MPEG application, a plurality of message queues, and a servo software. An optical disc reader is controlled and directed by the servo software in order to read the information on the optical disc. Both the MPEG application and the servo software share at least a common data buffer as the storage of read-out information. In the embodiment, the MPEG application receives information from the servo software for playback by means of the plurality of message queues. In this regards, when needing information on optical disc, the MPEG application issues a data request message to one of the plurality of message queues. Next, data request messages in the message queue are re-ordered by the message queue and are received by the servo software. According to instructions of the data request message, the optical disc reader controlled by the servo software read information on optical disc. The read-out information would be stored in the data buffer consequently. A response message is replied to another message queue. After re-ordered in the message queue, it would be received and interpreted by the MPEG application. Accordingly, the MPEG application could acquire the requested data in the data buffer.

The present invention also provides a multi-tier structure, which comprises an application layer, a middle layer, and a servo layer. The application layer includes at least a load manager for issuing command messages by the requests of a rendering engine and a file system. The middle layer comprises at least one command queue and a complete queue, which may be simple First-In-First-Out structures or some kinds of priority queues. A servo software, included in the servo layer, is configured to control an optical disc reader for reading information on optical disc. The servo layer and application layer share at least one data buffer as a memory space for the storage of read-out information. The multiple message queues are used to bridge and communicate with the application and servo layers. In this regards, when information on optical disc is needed, the rendering engine or the file system would notify the load manager. The requests would be processed, re-ordered, and scheduled by the load manager at first. A command message would be sent to the command queue in the middle layer at first and the servo software, in turn. According to instructions of the data request message, the optical disc reader controlled by the servo software read information on optical disc. The read-out information would be stored in the data buffer consequently. Next, a response message, representing the completion of reading and storing, is replied to the complete queue by the servo software. The response message would be received and further dispatched to the requester by the load manager. Once the rendering engine or the file system receives the response message, it could acquire information stored in the data buffer.

Multitasking and common data buffer sharing techniques provided by the present invention are used to save time and space wasted in the duplication process of the prior art. Besides, a middle layer composed by multiple message queues is also taken as a communicative bridge between the application and servo layers. Message queues of the middle layer could be used as pipelines for staging multiple data request messages and corresponding response messages concurrently from the both ends, the application and servo layers. Moreover, the size of data buffer may be larger than the size of single requested information, the data buffer could store more than one requested data accordingly. However, there could be multiple data buffers for storing multiple data in the present invention, too. Summarized, the software architecture provided by the present invention could improve the over whole data transfer efficiency. In addition to the middle layer, the application and servo layers could be also implemented as parts of pipelines. Furthermore, once the architecture implemented in multi-threaded operating system, parallel processing could be also achieved as each layer implemented in concurrent threads. For example, MPEG layer could simultaneously issue data request messages, receive response messages, and retrieve requested data from the data buffer. Hence, both the MPEG and servo layers could always work in any given moment, unlike that the servo chip and MPEG chip of prior art have to stay idle and wait for each other. At final, the architecture disclosed by this invention is also suitable for implemented as an integrated multimedia optical disc playback system-on-chip.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a block diagram shows conventional playback architecture;

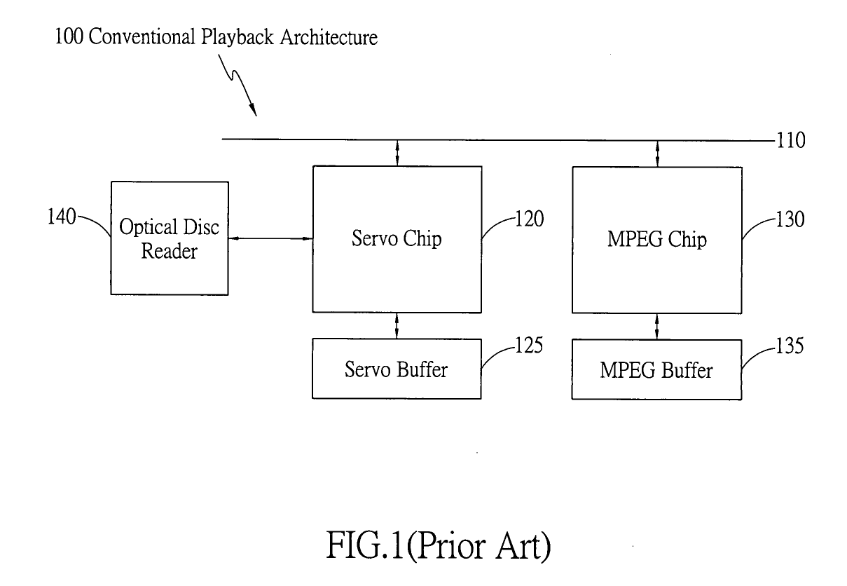

FIG. 2 is a flowchart diagram of the architecture shown in the FIG. 1;

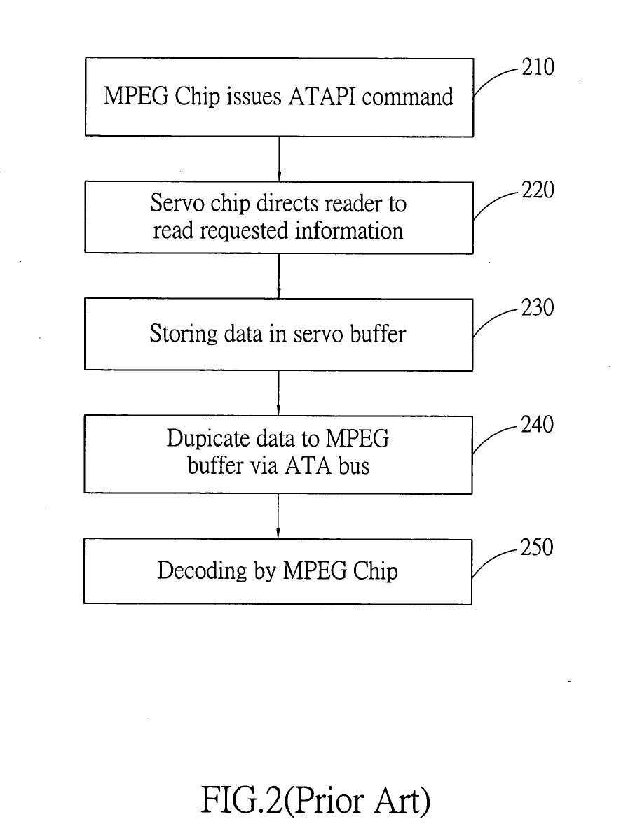

FIG. 3 is a block diagram shows a software architecture of an embodiment in accordance with the present invention;

FIG. 4 is a flowchart diagram of the embodiment shown in the FIG. 3;

FIG. 5 is a block diagram shows a software architecture of another embodiment in accordance with the present invention;

FIG. 6 is a flowchart diagram of the software architecture shown in the FIG. 5; and

FIG. 7 is a block diagram shows a software architecture of another embodiment in accordance with the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

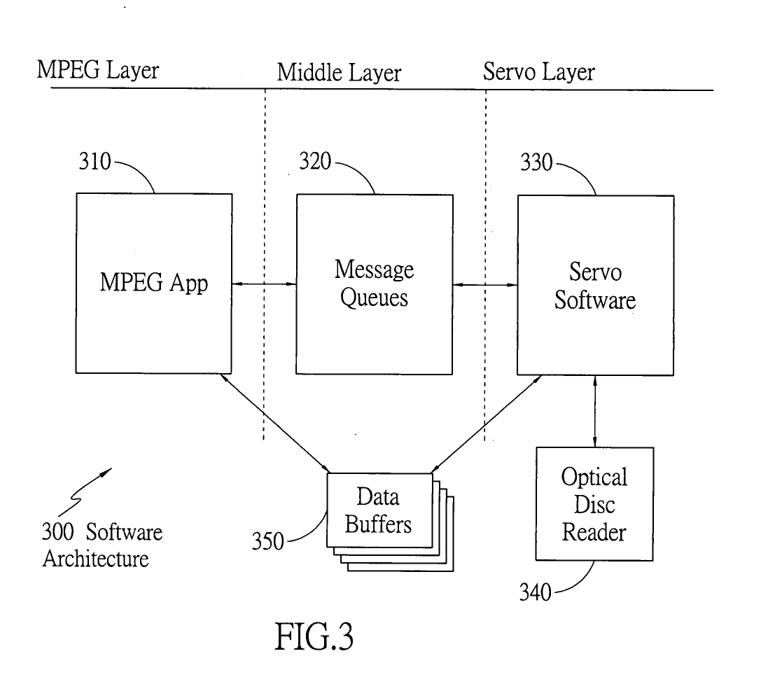

Please refer to the FIG. 3, which is a block diagram shows a software architecture 300 of an embodiment in accordance with the present invention. The software architecture 300 is a multi-tier structure, which comprises a MPEG layer, a middle layer, and a servo layer. In this architecture 300, at least one MPEG application 310 of the MPEG layer is included. For example, the MPEG application 310 may be a movie player or a software manager, which could handle multiple MPEG data requests from different software concurrently.

As shown in the FIG. 3, the middle layer comprises a plurality of message queues 320 for receiving message from the MPEG and servo layers. Similarly, the messages of the plurality of message queues 320 could be also received by the MPEG and servo layers. Moreover, the plurality of message queues 320 could be implemented as simple FIFO queues or some kinds of priority queues. As simple FIFO queues, the messages are ordered by receiving time; as some kinds of priority queues, the priority-related information may be retrieved from the messages themselves. In this embodiment, the plurality of message queues 320 could be subscribed by the MPEG layer, the servo layer, and/or other software. Whenever messages are entered, the plurality of message queues 320 would notify the subscribers. Since message queue is a well-known technique, this disclosure does not explain the message queue in details.

As shown in the FIG. 3, the servo layer at least comprises a servo software 330 for controlling at least one optical disc reader 340. Using this optical disc reader 340, the servo software 330 could read information on optical discs. The servo software 330 and the MPEG application 310 share at least one common data buffer 350. Besides, the plurality of message queues 320 could also share the same data buffer 350 for storing the messages. In this present invention, the data buffer 350 could be a physical composition formed by a continuous memory space or a logical composition formed by discrete memories blocks. In fact, as long as the data buffer 350 could be access by the servo software 330, MPEG 310, and the plurality of message queues 330, the present invention does not restrict the number of physical data buffer.

In one example of the embodiment, the software architecture 300 could be implemented at a multi-tasking real-time operating system wherein each layer is implemented as at least one task or task group which could be executed concurrently. On another example of the embodiment, the software architecture 300 could be implemented at a multi-threaded operating system wherein each layer is implemented as at least one thread or thread group which could be executed concurrently.

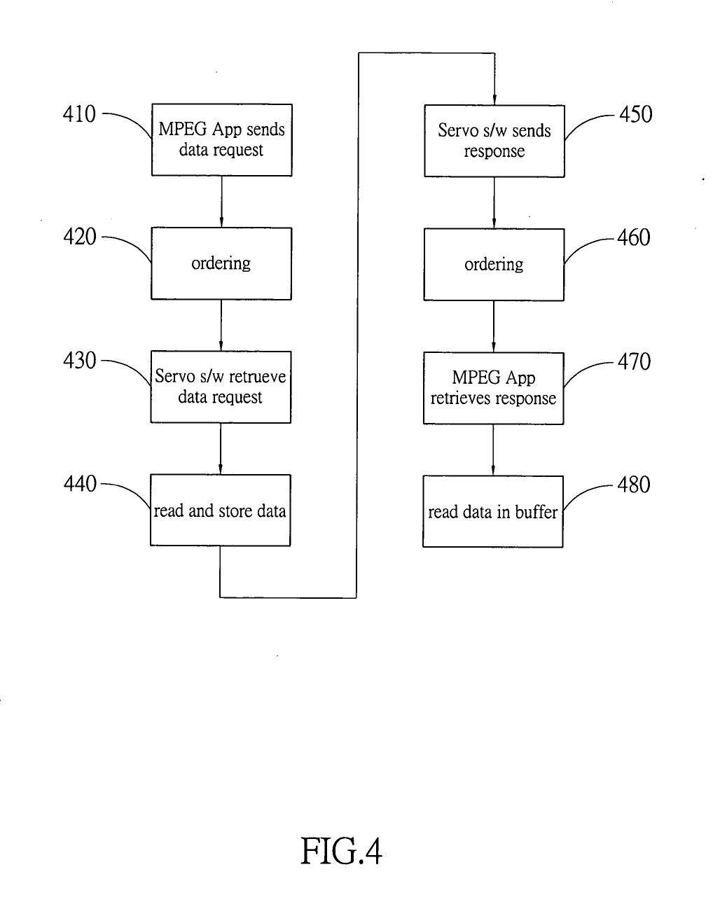

Please refer to the FIG. 4, which is a flowchart diagram of the embodiment shown in the FIG. 3. At first, in step 410, a data request message is issued, by the MPEG application 310, to one of the plurality of message queues 320. After receiving the data request message, the message queue 320 performs ordering on the received message according to the received time or priority-related information tagged on the received message in behavior of the type of the message queue 320 in step 420. Next, in step 430, the message is retrieved by its subscribers, such as the servo software 330. However, the present invention does not restrict that whether the implemented mechanisms of the message queue 320 are polling or pushing. After receiving the data request message, the servo software 330 would read information from the optical disc according to the instructions of this data request message and store the read-out information in the data buffer 350. Moreover, the data request message may instruct the pre-allocated space of the data buffer 350, the intended blocks of the optical disc, the retry number, and/or any other useful parameters beneficial to the step 440. Once more, the present invention does not restrict the content of this data request message.

As shown in the FIG. 4, the servo software 330 would issue a response message to another one of the plurality message queues 320 after reading and storing information in step 450. Similar to the data request message, the present invention does not restrict the content of this response message, which may include the storage address of the data buffer 350, the length or size of read-out information, and/or any other useful parameters beneficial to the MPEG application 310. As usual, the response message would be also ordered by the message queue 320 according to the received time or its priority-related information in step 460. In following step 470, the MPEG application 310 retrieves the response message from the message queue 320. At last, after interpreting the response message, the MPEG application 310 could acquire the demanded data from the data buffer 350.

In a preferred embodiment, the plurality of message queues could be pipelined for staging the data request messages and corresponding response messages from both ends, the MPEG application 310 and the servo software 330. Furthermore, since the size of data buffer 350 may be larger than data size of a single request, multiple requested data could be stored in the data buffer simultaneously. Therefore, parallel processing could be achievable for the sake of pipeline provided by the present invention. The over whole efficiency could be improved accordingly. Once the present invention is implemented at the multi-threaded operating system, parallel processing could be also achieved by implementing the layers into concurrent threads. For example, the MPEG layer could issue data request message, retrieve response message, and acquire read-out data from the data buffer 350 simultaneously. In such case, both the MPEG layer and the servo layer would be kept busy at any given moment unlike the situation that the servo chip 120 and the MPEG chip 130 have to wait for each other in the prior art.

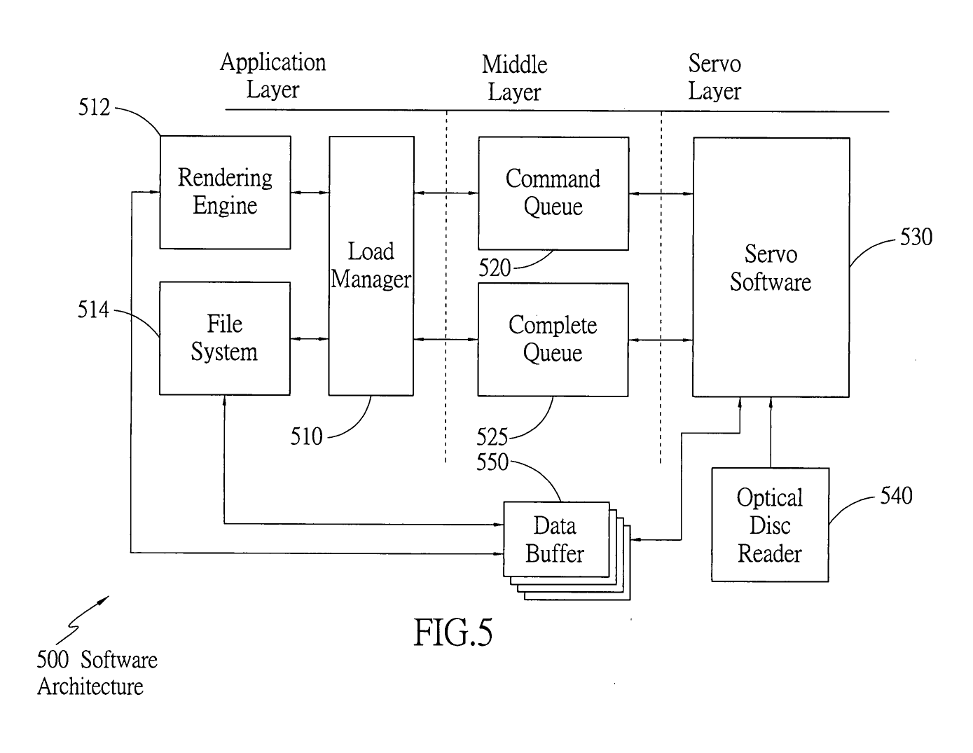

Please refer to the FIG. 5, which is a block diagram of a software architecture 500 of another embodiment in accordance with the present invention. Similar to the embodiment shown in the FIG. 3, the software architecture 500 also comprise an application layer, a middle layer, and a servo layer. In this regard, the application layer comprises a load manager 510, a rendering engine 512, and a file system 514. The rendering engine 512 is a multimedia player for playing multimedia information on the optical disc. For this purpose, the rendering engine 512 may comprise MPEG and/or other compression/decompression functions. The file system 514 is configured to handle file structure of optical disc. Except for the rendering engine 512 and the file system 514, other software or application may have needs for the information on optical disc. A software access gateway is provided by the load manager 510 for managing all requests of information on optical disc. The data request messages, issued by the rendering engine 512 and the file system 514, would be scheduled, ordered, and packed by the load manager 510.

As shown in the FIG. 5, the middle layer comprises a plurality of message queues for receiving messages came from the application and servo layers. Similarly, the application and servo layers could acquire messages from the plurality of message queues. In this embodiment, the middle layer comprises a command queue 520 and a complete queue 525. The command queue 520 and complete queue 525 may be simple FIFO queues or some kinds of priority queues. Since message queue is a well-known technique, this disclosure does not explain the message queue in details.

As shown in the FIG. 5, the servo layer comprises at least one servo software 530, which controls at least one optical disc reader 540. With the help of the optical disc reader 540, information on optical disc could be read by the servo software 530. The servo software 530, the rendering engine 512, and file system 514 could share a common data buffer 550. Moreover, the plurality of message queues 520 and 525 also could share this data buffer 550.

In one example of the embodiment, the software architecture 500 could be implemented at a multi-tasking real-time operating system wherein each layer is implemented as at least one task or task group which could be executed concurrently. On another example of the embodiment, the software architecture 500 could be implemented at a multi-threaded operating system wherein each layer is implemented as at least one thread or thread group which could be executed concurrently.

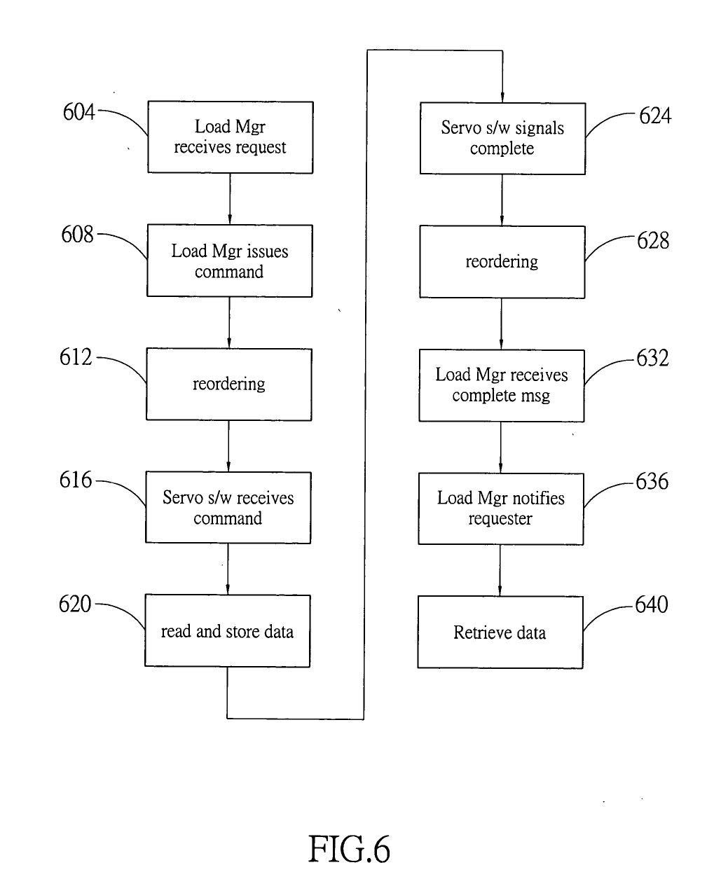

Please refer to the FIG. 6, which is a flowchart diagram of the software architecture 500 shown in the FIG. 5. At first, the load manager 510 receives a data request message from the rendering engine 512 or the file system 514 in step 604. In this step, the data request message could be ordered, scheduled, transformed, and/or any further manipulation by the load manager 510. Next, in the following step 608, the load manager 510 issues a command message to the command queue 520. All messages stayed in the command queue 520 would be re-ordered according to their received time and/or any other priority-related information in step 612. In the next step 616, the servo software 530 would receive this command message. According to the instructions of this command message, the servo software 530 would read intended information on optical disc in step 620 and store it into somewhere in the data buffer 550. In this regards, the command message may comprise the pre-allocated space of the data buffer 550, the intended block of optical disc, the retry number, and/or any other parameter beneficial to the performing of following step 640. In other words, the present invention does not restrict the content of the command message.

As shown in the FIG. 6, after reading and storing information, a complete message would be sent to the complete queue 525 by the servo software 530 in step 624. Similarly, the present invention does not restrict the content of the complete message, which may comprise the storage address of the data buffer 550, the length or size the read-out information, and/or any other parameters beneficial to information retrieve of the rendering engine 512 or the file system 514. Next, the complete queue would re-order contained messages in following step 628 according to their received time and/or priority-related information. In step 632, the complete message would be received by the load manager 510 from the complete queue 525. In turn, the load manager 510 has to return the complete message to the source of corresponding data request message, for example, the rendering engine 512 or the file system 514, in step 636. At last, after interpreting the complete message, the rendering engine 512 or the file system 514 could retrieve the requested data from the data buffer 550 in the last step 640.

In this preferred embodiment, the plurality of message queues 520 and 525 could be pipelined for staging the data request messages and corresponding response messages from both ends, the load manager 510 and the servo layer. Furthermore, since the size of data buffer 350 may be larger than data size of a single request, multiple requested data could be stored in the data buffer simultaneously. Therefore, parallel processing could be achievable for the sake of pipeline provided by the present invention. The over whole efficiency could be improved accordingly. Once the present invention is implemented at the multi-threaded operating system, parallel processing could be also achieved by implementing the layers into concurrent threads. For example, the MPEG layer could issue data request message, retrieve response message, and acquire read-out data from the data buffer 550 simultaneously. In such case, both the MPEG layer and the servo layer would be kept busy at any given moment unlike the situation that the servo chip 120 and the MPEG chip 130 have to wait for each other in the prior art.

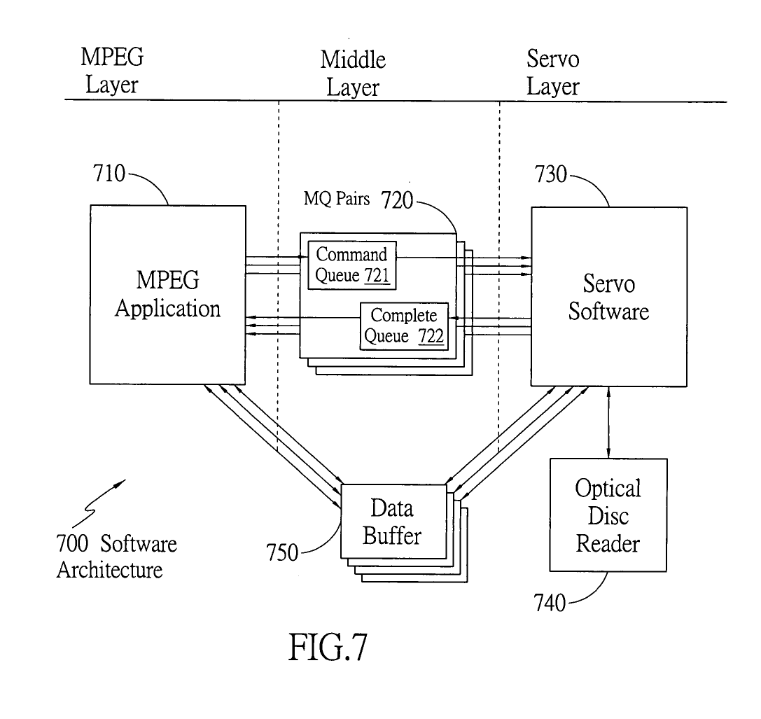

Please refer to the FIG. 7, which is a block diagram shows a software architecture 700 of another embodiment in accordance with the present invention. Similar to the software architecture 300 shown in the FIG. 3, the architecture 700 comprises a MPEG layer, a middle layer, and a servo layer. In this architecture 700, at least one MPEG application 710 of the MPEG layer, a plurality of message queue pairs 720, which comprises a command queue 721 and a complete queue 722, of the middle layer, and a servo software 730 controlling at least one optical disc reader 740 of the servo layer are included. Using this optical disc reader 740, the servo software 730 could read information on optical discs. The servo software 730 and the MPEG application 710 share a plurality of common data buffers 750. Besides, the plurality of message queues pairs 720 could also share the same data buffers 750 for storing the messages.

In one example of this embodiment, the plurality of message queue pairs 720 are one-to-one mapping to the plurality of data buffers 750. In other words, every pair of the command queue 721 and the complete queue 722 is corresponding to one of the plurality of data buffers 750.

Besides, in another example of the embodiment, the software architecture 700 could be implemented at a multi-tasking real-time operating system wherein each layer is implemented as at least one task or task group which could be executed concurrently. On another example of the embodiment, the software architecture 700 could be implemented at a multi-threaded operating system wherein each layer is implemented as at least one thread or thread group which could be executed concurrently.

In any given moment, the MPEG application 710 sends a plurality of data request messages to the plurality of command queues 721 of the plurality of message queue pairs 720. At the same time, the servo software 730 receives another batch of data request messages, previously sent by the MPEG application 710, from the plurality of command queues 721, read the plurality of requested data with the help of the optical disc reader 740, store the plurality of requested data into the plurality of data buffer 750 corresponding to the plurality of command queues 721, and return a plurality of response messages, corresponding to the batch of data request messages, to the plurality of complete queues 722. Meanwhile, the MPEG application 710 could receive another batch of response messages while sending data request messages, and retrieve data indicated by the batch of response messages.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

1. A MPEG-servo system for multimedia optical disc playback, comprising:
a plurality of message queues, further comprising a first queue and a second queue;
a MPEG module for sending a data request message to said first queue and receiving a response message corresponding to said data request message from said second queue; and
a servo module for receiving said data request message, reading a data requested by said data request message from an optical disc reader controlled by said servo module, and sending said response message corresponding to said data request message to said second queue.

2. A MPEG-servo system of claim 1, wherein said data request message comprising priority-related information.

3. A MPEG-servo system of claim 1, further comprising a data buffer which can be accessed commonly by said servo module and said MPEG module.

4. A MPEG-servo system of claim 3, wherein said data requested is stored in said data buffer by said servo module, and said data requested is read from said data buffer by said MPEG module according to said response message.

5. A MPEG-servo system of claim 3, wherein said plurality of message queues, said MPEG module, and said servo module are implemented as concurrent executable threads.

6. A data communication method between MPEG and servo for multimedia optical disc playback, comprising:
sending a data request message by a MPEG module;
receiving said data request message by a servo module, reading a data requested by said data request message from an optical disc loaded in an optical disc reader controlled by said servo module, and sending a response message corresponding to said data request message; and
receiving said response message and reading said data requested according to said response message, by said MPEG module, while sending another data request message.

7. A data communication method of claim 6, wherein said MPEG module and said servo module are implemented as concurrent executable threads.

8. A data communication method of claim 6, further comprising:
storing, by said servo module, said data requested by said data request message in a data buffer, wherein said data buffer can be accessed commonly by said servo module and said MPEG module.

9. A data communication system for a multimedia optical disc playback system, comprising:
a command queue;
a complete queue;
a load manager, for receiving a data request message from a request module, sending a command message to said command queue according to said data request message, and retrieving a complete message, corresponding to said command message, from said complete queue;
a servo module, for receiving said command message from said command queue, reading a data requested by said command message from an optical disc loaded in an optical disc reader controlled by said servo module, and sending said complete message, corresponding to said command message, to said complete queue; and
a data buffer, for storing a plurality of data requested read out by said servo module and for reading said plurality of data requested according to said complete message by said load manager.

10. A data communication system of claim 9, wherein said data request message comprising priority-related information.

11. A data communication system of claim 9, wherein said request module comprising a file system, managing file structure of said optical disc.

12. A data communication system of claim 9, wherein said request module comprising a rendering engine, displaying MPEG data on said optical disc.

13. A data communication system of claim 10, wherein said load manager performs ordering, scheduling, and data transforming of said data request message.

14. A data communication system of claim 9, wherein said data buffer can be accessed commonly by said servo module and said request module.

15. A data communication system of claim 14, wherein said data buffer can be accessed commonly by said command queue and said complete queue.

16. A data communication method between MPEG and servo for multimedia optical disc playback, comprising:
providing a plurality of message queue pairs, wherein each message queue pair further comprising a command queue and a complete queue;
sending a plurality of data request messages, by a MPEG module, to said plurality of command queues of said plurality of message queue pairs;
receiving said plurality of data request messages, by a servo module, from said plurality of command queues, reading a plurality of data requested by said plurality of data request messages from an optical disc loaded in an optical disc reader controlled by said servo module, and sending a plurality of response messages, corresponding to said plurality of data request messages, to said plurality of complete queues of said plurality of message queue pairs;
receiving said plurality of response messages and reading said plurality of data requested by said plurality of data request messages according to said plurality of response messages, by said MPEG module, while sending another plurality of data request messages.

17. A data communication method of claim 16, wherein said MPEG module and said servo module are implemented as concurrent executable threads.

18. A data communication method of claim 16, further comprising:
storing, by said servo module, said plurality of data requested by said data request message in a plurality of data buffers, wherein said plurality of data buffers can be accessed commonly by said servo module and said MPEG module.
